(19) United States
(12) Patent Application Publication
(10) Pub. No.: US 2014/0246040 A1
(43) Pub. Date: Sep. 4, 2014

(54) HAIRDRYER WITH CONDITIONER DISTRIBUTION

(71) Applicants: Asia Stovall, Grand Bay, AL (US); Adrian Dixon, Grand Bay, AL (US)

(72) Inventors: Asia Stovall, Grand Bay, AL (US); Adrian Dixon, Grand Bay, AL (US)

(21) Appl. No.: 14/156,664

(22) Filed: Jan. 16, 2014

Related U.S. Application Data
(60) Provisional application No. 61/772,165, filed on Mar. 4, 2013.

(51) Int. Cl. A61Q 5/12; A45D 20/00

(52) U.S. Cl. CPC A61Q 5/12; A45D 20/00
USPC 132/202; 34/60

(57) ABSTRACT

A hair dryer with conditioning attachment including: a L-shaped body; an emission end; a conditioner attachment end; a conditioner container attached to the conditioner attachment end, where the conditioner container includes a compartment for storing hair conditioner; and a flow of hair conditioner through the emission end during use the hair dryer. The hair dryer may also include control buttons.

### CROSS REFERENCE TO OTHER APPLICATIONS

This application claims priority to U.S. Provisional Application Ser. No. 61/772,165 filed on Mar. 4, 2013.

### BACKGROUND OF THE INVENTION

1. Field of Invention

The present invention relates to a hairdryer that includes an attachment that enables the distribution of hair conditioner during the operation of hairdryer.

2. Description of Related Art

As known hairstyling and conditioning involves the washing, drying and styling of individual's hair. Many individuals use portable handheld hairdryers in order to dry their hair after washing their hair. In order that the hair remains pliable and suitable for styling, a conditioner is usually applied or combed through while the hair is being dried. This enables the individual to style and comb the hair after the drying process is complete. As an alternative, an individual may sit under a hairdryer and then conditioning is applied after the hair is dry or in other instances a conditioner is placed on the hair prior to drying and then the individual may sit under a hairdryer to dry their hair after washing.

Needless to say the process of drying wet hair during styling and combing in most instances requires the application of conditioner before, during or after the drying process. Consequently, it would be advantageous to have a hairdryer that distributes conditioner onto the hair as heated air is transported across the hair of the individual during the drying process.

### SUMMARY OF THE INVENTION

The present invention relates to a hair dryer with conditioning attachment including: a L-shaped body; an emission end; a conditioner attachment end; a conditioner container attached to the conditioner attachment end, where the conditioner container includes a compartment for storing hair conditioner; and a flow of hair conditioner through the emission end during use the hair dryer. The hair dryer may also include control buttons.

The present invention also relates to a method of hair conditioning application, where the method includes the steps of: attaching a hair conditioning container to a non-emission end of a hair dryer; filling the hair conditioning container with hair conditioner; transferring a stream of the hair conditioner through the hair dryer; and emitting the hair conditioner through an hot air emission of the hair dryer.

### BRIEF DESCRIPTION OF DRAWINGS

FIG. 1 depicts a hairdryer that includes an attachment to support the distribution of conditioner onto an individual's hair through the hairdryer.

### DETAILED DESCRIPTION

The present invention relates to a hairdryer that includes an attachment that assists in the distribution of conditioner through the hairdryer during the operation thereof. The hairdryer according to present invention helps to eliminate the additional step of applying conditioner immediately before or after drying the hair. The present invention includes a hairdryer that has a complete conditioner attachment that draws conditioner through the hairdryer for application directly onto the hair during the drying operation.

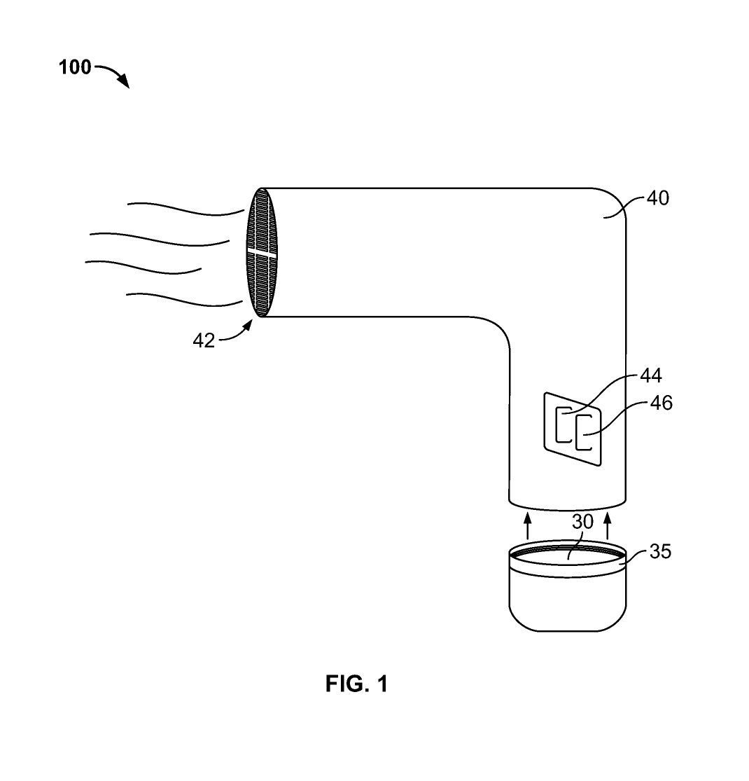

In reference to FIG. 1, a prospective view of a hairdryer 100 according to the present invention as depicted. The hairdryer 100 according to the present invention includes an L-shaped body 40. The L-shaped body 40 has an exhaust end 42 with exhaust heated air or hot air for application directly onto an individual's hair. Control buttons are provided on one side portion of the L-shaped body 40. A power control 44 and a power level indicator 46 are depicted in FIG. 1. These controls enable the user to control the operation of the hairdryer 100. Attached to a lower end 48 of the hairdryer 40 is a conditioning container 35. Within the container 35 is a compartment 30 that is used to hold and contain conditioner that's transmitted through the hairdryer 40.

The conditioner within the container 35 is drawn out of the compartment 30 and emitted out of an emission 42 of the hairdryer 40. So the hairdryer 40 emits heated or hot air out of the emission 42 and hair conditioner is also transmitted in the stream of air that flows through the emission 42 of the hairdryer 40. This device according to present invention provides the user with a hairdryer that emits both hot air and conditioner for application unto an individual's hair. The present invention improves the overall functioning of the hairdryer and also effectively provides conditioner for the scalp and hair of the individual that's using the hairdryer. The instant invention has been shown and described in what it considers to be the most practical and preferred embodiments. It is recognized, however, that departures may be made there from within the scope of the invention and that obvious modifications will occur to a person skilled in the art.

What is claimed is:

1. A hair dryer with conditioning attachment comprising:
a. a L-shaped body;
b. an emission end;
c. a conditioner attachment end;
d. a conditioner container attached to the conditioner attachment end, where the conditioner container includes a compartment for storing hair conditioner; and
e. a flow of hair conditioner through the emission end during use the hair dryer.

2. The hair dryer according to claim 1, further including control buttons.

3. A method of hair conditioning application including the steps of:
a. attaching a hair conditioning container to a non-emission end of a hair dryer;
b. filling the hair conditioning container with hair conditioner;
c. transferring a stream of the hair conditioner through the hair dryer; and
d. emitting the hair conditioner through an hot air emission of the hair dryer.
